(19) United States
(12) Patent Application Publication
(10) Pub. No.: US 2009/0166397 A1
(43) Pub. Date: Jul. 2, 2009

(54) BGA PACKAGE MODULE DESOLDERING APPARATUS AND METHOD

(75) Inventor: Liang MENG, Guangdong (CN)

Correspondence Address: BROWDY AND NEIMARK, P.L.L.C.;624 NINTH STREET, NW, SUITE 300, WASHINGTON, DC, 20001-5303, US

(73) Assignee: UNIVERSAL SCIENTIFIC INDUSTRIAL CO., LTD., Tsao Tuen (TW)

(21) Appl. No.: 12/257,225

(22) Filed: Oct. 23, 2008

(30) Foreign Application Priority Data
Dec. 26, 2007 (TW) 96150315

(51) Int. Cl. B23K 1/018; B23K 37/00

(52) U.S. Cl. 228/191; 228/46

(57) ABSTRACT

A BGA package module desoldering apparatus for detaching a chip module from a circuit board is disclosed to include a heat source for heating the chip module, and radiators each having a tank and a refrigerant received in the tank for attaching to the circuit devices of the circuit board around the chip module to be detached to shield the circuit devices against the heat energy from the heat source and to lower the temperature of the circuit devices during heating of the chip module by the heat source.

### BACKGROUND OF THE INVENTION

1. Field of the Invention

The present invention relates to ball grid array (hereinafter referred to as “BOGA”) package desoldering technology and more particularly, to a BOA package module desoldering apparatus that prevents thermal damage or short circuit when desoldering a BGA package. The invention relates also to a BGA package desoldering method.

2. Description of the Related Art

Ball grid array (BGA) is one type of packaging for surface-mounted integrated circuits. In a BOA, solder bumps are stuck to the bottom of the chip module and arranged in an array. The chip module is placed on a PCB that carries copper pads in a pattern that matches the solder bumps. The assembly is then heated, causing the solder bumps to melt and soften. The solder bumps then hold the chip module in alignment with the PCB, at the correct separation distance, while cooling and solidifying. In recent years, BOA packaging has been intensively used to gradually replace conventional leadframe packaging to support a chip module and act as its input/output terminal.

If the chip module is discovered unable to function normally during the manufacturing process, the engineer must rework the package, i.e., using a heat source to soften the solder bumps and then detaching the chip module from the PCB for examination and repair and then soldering the repaired chip module to the PCB. However, when desoldering the solder bumps of the chip module, the thermal energy may cause the electrolyte to flow out of the capacitors that are mounted in the PCB around the chip module, thereby causing damage of the capacitors. Further, the thermal energy may soften the solder bumps of the other surrounding chip modules, which causes a short circuit in the other surrounding chip modules or collapse of the other surrounding chip modules. When this problem occurs, the other surrounding circuit devices shall have to be reworked, thereby increasing rework labor and costs.

### SUMMARY OF THE INVENTION

The present invention has been accomplished under the circumstances in view. It is the main object of the present invention to provide a BGA package desoldering apparatus and method, which protects surrounding circuit devices from heat damage and short circuit when desoldering a chip module.

To achieve this and other objects of the present invention, the BGA package desoldering apparatus comprises a heat source and at least one radiator. The heat source is adapted for heating the chip module to be detached. The at least one radiator is to be attached to the surrounding circuit devices to keep the surrounding circuit devices cool. Each radiator has a tank, and a refrigerant mounted in the tank.

To achieve this and other objects of the present invention, the BOA package desoldering method comprises the steps of: a) providing a radiator that comprises a tank and a refrigerant received in the tank and attaching the radiator to a surrounding circuit device near the chip module to be detached, and b) providing a heat source and operating the heat source to heat the chip module to be detached.

Further, the radiator corresponds to the circuit device in shape. The circuit device can be a capacitor, battery, socket, or chip module. The refrigerant can be water or a chemical agent. The radiator further comprises a cover that covers the top side of the tank, and an absorber put in the tank to absorb the refrigerant.

### BRIEF DESCRIPTION OF THE DRAWING

FIG. 1 is a perspective view of the preferred embodiment of the present invention.

FIG. 2 is a side view of the preferred embodiment of the present invention.

### DETAILED DESCRIPTION OF THE INVENTION

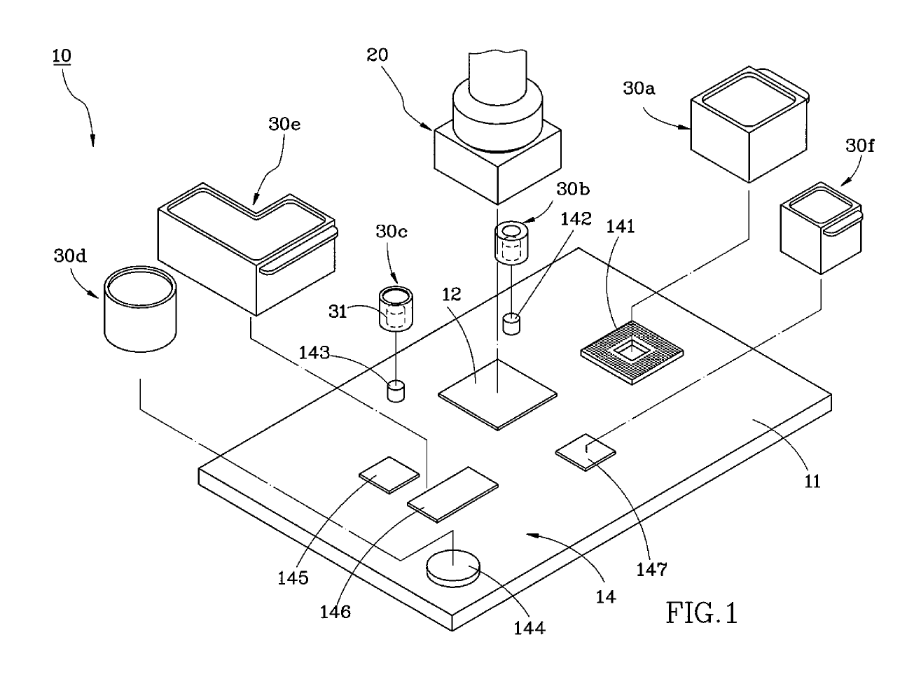

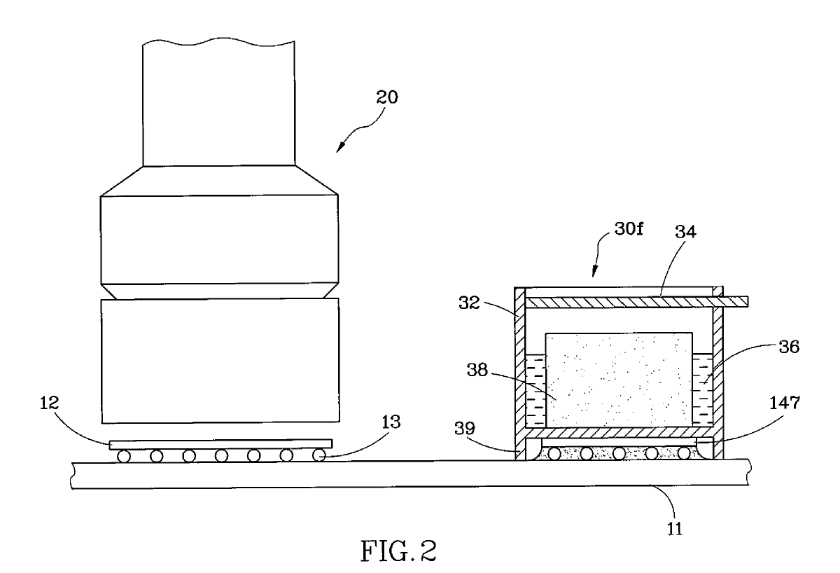

Referring to FIGS. 1 and 2, a BGA package module desoldering apparatus 10 in accordance with the present invention is adapted for detaching a chip module 12 from a circuit board 11. The chip module 12 has an array of solder bumps 13 stuck to its bottom side and bonded to the circuit board 11. The circuit board 11 has installed therein multiple circuit devices 14, including a socket 141, two capacitors 142 and 143, a battery 144 and other three chip modules 145-147. The BGA package desoldering apparatus 10 comprises a heat source 20 and multiple radiators 30a-30f.

The heat source 20 is adapted to heat the chip module 12, thereby softening the solder bumps 13. The working principle of the heat source 20 is well known to any people skilled in the art, and therefore no further detailed description in this regard is necessary.

The radiators 30a-30f correspond to the circuit devices 14 in shape and size, i.e., the radiators 30a-30f may show a rectangular shape, circular shape, annular shape, L-shape, or any of a variety of other shapes to fit the shapes of the circuit devices 14. As shown in FIG. 2, each of the radiators 30a-30f comprises a tank 32, a cover 34, a refrigerant 36, and an absorber 38. The cover 34 is provided at the top side of the tank 32. The refrigerant 36 can be water or a chemical agent received in the tank 32. The absorber 38 is, for example, a sponge received in the tank 32 to absorb the refrigerant 36. The cover 34 and the absorber 38 are to avoid splashing of the refrigerant 36 out of the tank 32 during movement of the respective radiator 30a-30f Further, each of the radiators 30a, 30c-30f further comprises a shielding ring 39 disposed at the bottom side of the tank 32 for surrounding the respective circuit devices 14.

During application of the BGA package desoldering apparatus 10, the user needs to move the radiators 30a-30f to the top side of the respective circuit devices 14 and to closely attach the radiators 30a-30f to the respective circuit devices 14. Further, one radiator 30e can be attached to the circuit devices 145 and 146 that are disposed adjacent to each other. Thereafter, the user moves the heat source 20 to the top side of the chip module 12 to heat the chip module 12, thereby softening the solder bumps 13. When the solder bumps 13 are softened, the user can then remove the chip module 12 from the circuit board 11.

During heating, the radiators 30a-30f shield the circuit devices 14 against thermal energy from the heat source 20, and at the same time the circuit devices 14 release the absorbed heat energy to the radiators 30a-30f, avoiding damage or short circuit of the circuit devices 14 due to its high temperature or a high temperature of the solder bumps 13.

Further, the cover 34 may be eliminated according to the designer's requirement to facilitate heat dissipation of the radiators 30a-30f.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A BGA package module desoldering apparatus adapted for detaching a chip module from a circuit board that carries said chip module and at least one circuit device around said chip module, the BGA package module desoldering apparatus comprising:
a heat source adapted for heating said chip module; and
at least one radiator adapted for attaching to said at least one circuit device of said circuit board to shield said at least one circuit device against heat energy from said heat source, each said radiator comprising a tank and a refrigerant received in said tank.

2. The BOA package module desoldering apparatus as claimed in claim 1, wherein the radiator corresponds to the circuit device of said circuit board in shape.

3. The BGA package module desoldering apparatus as claimed in claim 1, wherein the circuit device includes at least one of the group of capacitor, battery, socket, and chip module.

4. The BGA package module desoldering apparatus as claimed in claim 1, wherein said refrigerant is water.

5. The BOA package module desoldering apparatus as claimed in claim 1, wherein each said radiator further comprises an absorber received in said tank to absorb said refrigerant.

6. The BGA package module desoldering apparatus as claimed in claim 5, wherein said absorber is a sponge.

7. The BGA package module desoldering apparatus as claimed in claim 1, wherein each said radiator further comprises a cover covering said tank.

8. The BGA package module desoldering apparatus as claimed in claim 1, wherein each said radiator further comprises a shielding ring provided at a bottom side of the tank for surrounding the circuit device.

9. A BGA package module desoldering method for detaching a chip module from a circuit board that carries said chip module and at least one circuit device around said chip module, the BGA package module desoldering method comprising the steps of:
a). providing at least one radiator and attaching the radiator to the circuit device, wherein each said radiator comprising a tank and a refrigerant received in said tank; and
b). providing a heat source and operating said heat source to heat the chip module to be detached from said circuit board.

10. The BGA package module desoldering method as claimed in claim 9, wherein the radiator corresponds to the circuit device of said circuit board in shape.

11. The BGA package module desoldering method as claimed in claim 9, wherein the circuit device includes at least one of the group of capacitor, battery, socket, and chip module.

12. The BGA package module desoldering method as claimed in claim 9, wherein said refrigerant is water.

13. The BGA package module desoldering method as claimed in claim 9, wherein each said radiator further comprises an absorber received in said tank to absorb said refrigerant.

14. The BGA package module desoldering method as claimed in claim 13, wherein said absorber is a sponge.

15. The BOA package module desoldering method as claimed in claim 9, wherein each said radiator further comprises a cover covering said tank.

16. The BGA package module desoldering method as claimed in claim 9, wherein each said radiator further comprises a shielding ring provided at a bottom side of said tank for surrounding one said circuit device.
